(19) United States
(12) Patent Application Publication
(10) Pub. No.: US 2025/0027784 A1
(43) Pub. Date: Jan. 23, 2025

(54) METHOD AND SYSTEM FOR RECOMMENDING VEHICLE LOCATION

(71) Applicant: Gogoro Inc., Hong Kong (CN)

(72) Inventors: I-Fen Shih, Taoyuan City (TW); Yun-Chun Lai, Taoyuan City (TW)

(21) Appl. No.: 18/355,804

(22) Filed: Jul. 20, 2023

(51) Int. Cl. G01C 21/36

(52) U.S. Cl. CPC G01C 21/3685

(57) ABSTRACT

A computer-implemented method for recommending vehicle location is provided. Said method takes considerations of drifting effect during positioning of vehicle under a static state and analysis using various geographic data and historical positioning locations of the vehicle to recommend possible location of the vehicle to user, thereby assist user in finding the vehicle quickly on-site. Further provided is a system for recommending vehicle location.

### BACKGROUND

### Technical Field

The present disclosure relates to a positioning technique. More particularly, the present disclosure relates to a method for recommending vehicle location and the system thereof.

### Description of Related Art

Electric scooter-sharing provides advantages of reducing carbon dioxide emissions and facilitating mobility in metropolitan areas. Electric scooter-sharing is gradually changing the transportation industry following growth of sharing economy. To boost utilization rate of shared electric scooters, a primary task is to assist users in precise positioning of parking locations of electric scooters and shorten their time spent for searching vehicles. However, Global Navigation Satellite System (GNSS) coordinates reported by electric scooters in static state are prone to drifting effect. That is, although actual location of an electric scooter is static, the GNSS coordinates updated therefrom might still drift irregularly. Due to complex terrain consist of dense buildings of metropolitan areas, the drifting effect of GNSS coordinates will greatly affect users from finding electric scooters accurately. For example, a drifted GNSS coordinate may lead a user mistakenly enter an alley where the electric scooter is not located.

### SUMMARY

The present disclosure provides a computer-implemented method for recommending vehicle location. The method comprises the following steps: recording at least one positioning location of a vehicle at real-time as at least one historical positioning location of the vehicle; in response to receiving a control signal corresponding to the vehicle from a first mobile device of at least one mobile device, determining a reference location of the vehicle according to the at least one historical positioning location; according to a location relationship between the reference location and a current location of the at least one positioning location, generating a real-time recommendation location of the vehicle; and transmitting the real-time recommendation location to the at least one mobile device, and allowing each of the at least one mobile device to display the real-time recommendation location on an operational interface.

The present disclosure further provides a system for recommending vehicle location. The system comprises a vehicle, at least one mobile device and a server. The at least one mobile device comprises a first mobile device. The server is communicatively coupled with the vehicle and the at least one mobile device, and is configured to: record at least one positioning location of the vehicle at real-time as at least one historical positioning location of the vehicle; in response to receiving a control signal corresponding to the vehicle from the first mobile device, determine a reference location of the vehicle according to the at least one historical positioning location; according to a location relationship between the reference location and a current location of the at least one positioning location, generate a real-time recommendation location of the vehicle; and transmit the real-time recommendation location to the at least one mobile device, and allow each of the at least one mobile device to display the real-time recommendation location on an operational interface.

The above system and method take considerations of drifting effect during positioning of vehicle under static state and analysis of various geographic data and historical positioning locations of the vehicle to recommend possible location of vehicle to user, thereby assist user in finding the vehicle quickly on-site.

### BRIEF DESCRIPTION OF THE DRAWINGS

FIG. 1 is a functional block diagram of a system according to the present disclosure.

FIG. 2 is a flowchart of a method according to the present disclosure.

FIG. 3 is a flowchart of the method according to the present disclosure.

FIG. 4 is a schematic diagram for illustrating the method according to the present disclosure.

FIG. 5 is a schematic diagram of a screenshot of the mobile device for illustrating the method according to the present disclosure.

FIG. 6 is a schematic diagram for illustrating the method according to the present disclosure.

FIG. 7 is a schematic diagram of a screenshot of the mobile device for illustrating the method according to the present disclosure.

FIG. 8 is a detailed flowchart of the method according to the present disclosure.

FIG. 9 is a schematic diagram of a screenshot of the mobile device for illustrating the method according to the present disclosure.

FIG. 10 is a schematic diagram of a screenshot of the mobile device for illustrating the method according to the present disclosure.

FIG. 11 is a schematic diagram of a screenshot of the mobile device for illustrating the method according to the present disclosure.

FIG. 12 is a partial flowchart of the method according to the present disclosure.

### DETAILED DESCRIPTION

Reference will now be made to the accompanying drawings to describe embodiments of the present disclosure. The same reference numbers are used in the drawings to refer to the same or like components and method steps.

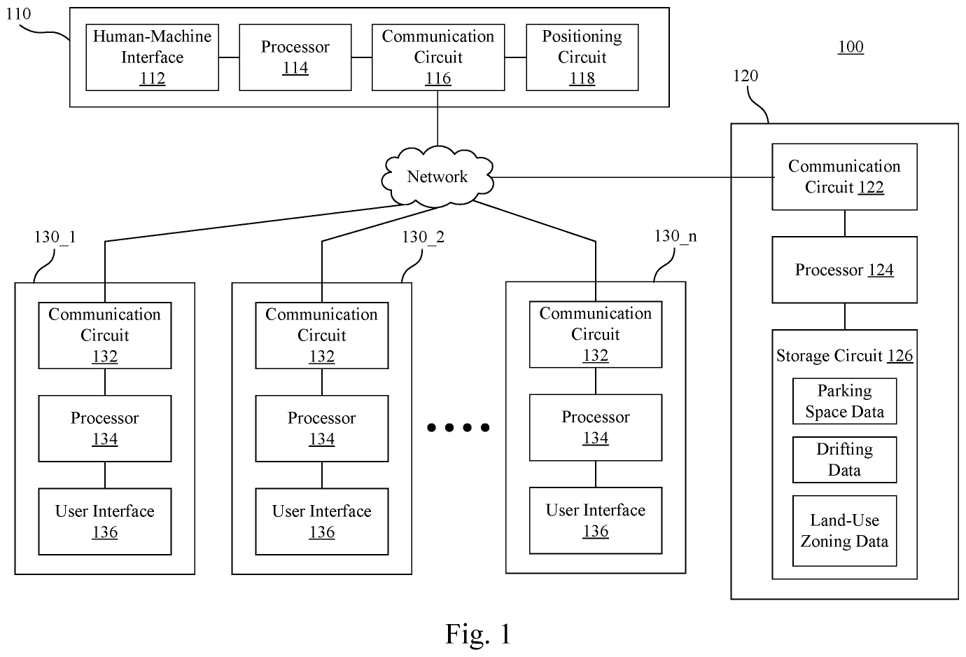

FIG. 1 is a simplified functional block diagram of a system 100 for recommending vehicle location according to one embodiment of the present disclosure. The system 100 comprises a vehicle 110, a server 120 and at least one mobile device 130_1-130_n.

In some embodiments, vehicle 110 may be an electric scooter, and mobile devices 130_1-130_n may be smart phones, tablet computers, notebook computers or other applicable logic computing devices. Users of mobile devices 130_1-130_n may be average consumers interacting with system 100 through specific application software installed in mobile devices 130_1-130_n for searching and renting vehicle 110 in participation of sharing economy. Users of mobile devices 130_1-130_n may also be operation and maintenance personnels in search of vehicle 110 through system 100 for maintaining or replacing batteries thereof.

Vehicle 110 comprises a human-machine interface 112, a processor 114, a communication circuit 116 and a positioning circuit 118. Human-machine interface 112 is an input-output interface, and may comprise a display (e.g., a dashboard), a speaker, at least one control assembly (e.g., a button, a throttle lever, a break lever, etc.) or any combination thereof. Communication circuit 116 is communicatively connected to server 120 via network to receive command from server 120. For example, server 120 may instruct vehicle 110 to switch between a locked state and an unlocked state. In some embodiments, when vehicle 110 is in locked state, user is kept from operating power system of vehicle 110 through human-machine interface 112; and when vehicle 110 is in unlocked state, user is enabled to operate power system of vehicle 110 through human-machine interface 112. Communication circuit 116 may further upload positioning locations generated by positioning circuit 118 to server 120. In some embodiments, communication circuit 116 may be implemented as a telematics control unit (TCU). In some embodiments, positioning circuit 118 may be implemented as a global positioning system (GPS) sensor or any other applicable positioning devices based in global navigation satellite system (GNSS), where positioning locations generated by positioning circuit 118 may comprise GPS coordinates.

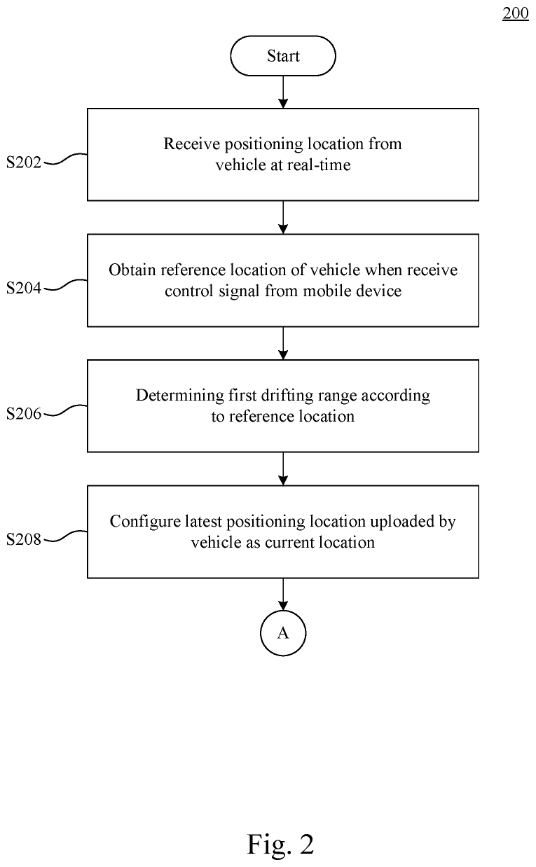

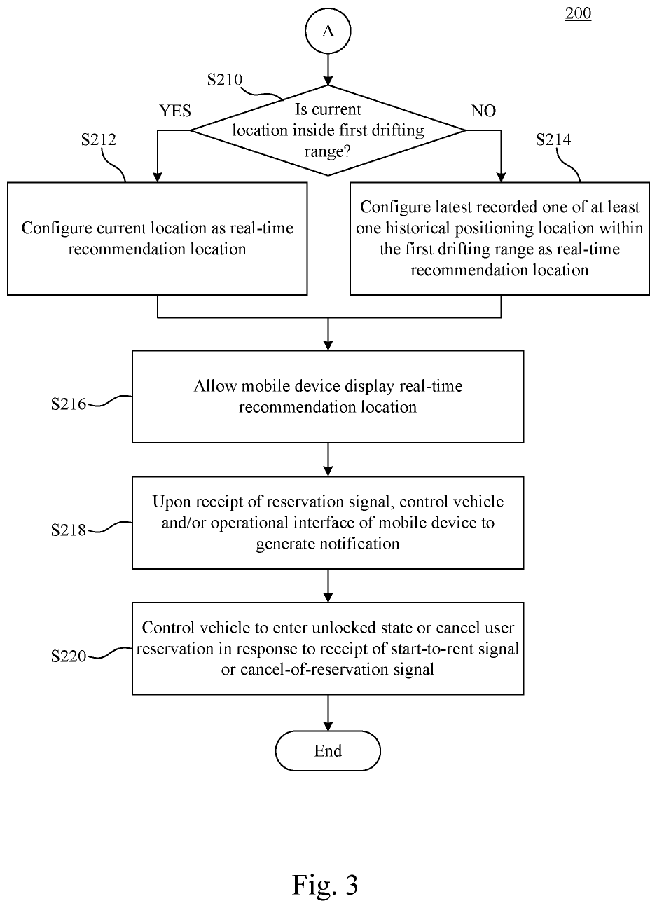

Server 120 comprises a communication circuit 122, a processor 124 and a storage circuit 126, and is communicatively connected with vehicle 110 and mobile devices 130_1-130_n via communication circuit 122. Storage circuit 126 is configured to store a plurality of parking space data and a plurality of drifting data (hereinafter collectively referred to as “auxiliary geographic data”). Server 120 may utilize auxiliary geographic data in storage circuit 126 to control mobile devices 130_1-130_n for assisting users in finding vehicle 110, where control means thereof will be described in detail in the following paragraphs with reference to FIGS. 2 and 3.

In some embodiments, parking space data may be acquired from governmental open data portal, and each parking space data may comprise a specific one or more addresses and/or latitude-longitude coordinates of the parking space. However, source of parking space data is not limited thereto, and may be acquired from other reliable sources.

In other embodiments, each drifting data corresponds to a specific geographical region, such as a specific lane, a specific section, etc., and records a drifting offset and a drifting direction regarding positioning error by positioning circuit 118 corresponding to an actual location at that specific geographical region. In some embodiments, server 120 may compare an actual location of vehicle 110 recorded by operation and maintenance personnels during on-site operation at a specific geographical region with a positioning location uploaded by positioning circuit 118 when vehicle 110 is at said actual location, so as to obtain a drifting data (including drifting offset and drifting direction) of the vehicle 110 at said specific geographical region corresponding to the actual location. In some embodiments, server 120 may record drifting data of vehicle 110 (and/or other one or more vehicles) observed in said specific geographical region during static or locked state. In other words, drifting data can be understood as a statistically derived possible deviation caused by drifting effect between positioning location uploaded by vehicle 110 to server 120 and actual location of vehicle 110 when parked at said specific geographical region for a period of time. It should be understood that means for obtaining drifting data is not limited thereto, and drifting data may be obtained via any observation manner or recording manner.

Each of mobile devices 130_1-130_n comprises a communication circuit 132, a processor 134 and a user interface 136. Communication circuit 132 is connected to the network and is supportive of third generation (3G), fourth generation (4G), fifth generation (5G) or other developing generations of mobile communication technique. User interface 136 may comprise a touch display, a button, a speaker, a light-emitting component or any combination thereof.

FIGS. 2-3 depict a flowchart of a method 200 for recommending vehicle location according to one embodiment of the present disclosure. In some embodiments, any combination of features in method 200 may be implemented by various computer-readable instructions stored in a non-transitory computer readable medium (e.g., storage circuit 126 of server 120, optical disk, hard disk, non-volatile random-access memory, etc.). When executing these computer-readable instructions by one or more processors (e.g., processor 124 of server 120), these instructions may cause a portion or complete of method 200 to be performed. It should be understood that method 200 may include greater or fewer steps than illustrated in the flowchart and the steps may be performed in any order as appropriate.

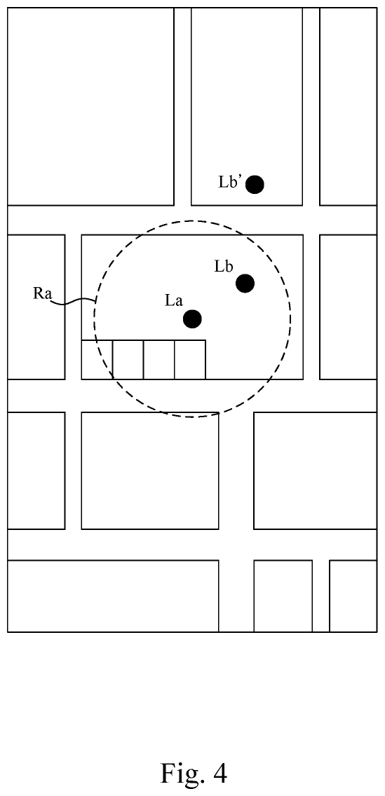

Reference is made to FIG. 2 and FIG. 4, where FIG. 4 is a schematic diagram for illustrating method 200. At step S202, server 120 receives positioning locations from vehicle 110 at real-time (e.g., positioning circuit 118 is configured to generate positioning locations of vehicle 110 following an upload period of a minute) and record the received positioning locations as at least one historical positioning location of vehicle 110, where the historical positioning locations may be stored in storage circuit 126. In other words, the historical positioning locations are a plurality of positioning locations received by server 120 at a plurality of time points during operation of vehicle 110.

At step S204, when server 120 receives a control signal from mobile device 130_1 (here user of mobile device 130_1 is assumed as current tenant of vehicle 110), server 120 determines one of the historical positioning locations uploaded by vehicle 110 during a period of it entering static state to receipt of control signal at server 120 as a reference location La of vehicle 110, e.g., one of the positioning locations uploaded during events such as motor shut-down, opening or closure of under-seat trunk, lowering of center stand or kick stand, etc. In preferred embodiments, said reference location La is a central location of at least one historical positioning location uploaded by vehicle 110 during period of it entering static state to receipt of control signal at server 120. For example, server 120 may record one or more positioning locations uploaded by vehicle 110 during following one or more events: motor shut-down, opening or closure of under-seat trunk, lowering of center stand or kick stand, etc.; server 120 may then determine a mean result of coordinates of these one or more positioning locations (e.g., central location of one or more coordinates) as reference location La upon receipt of control signal. However, means for calculating or obtaining reference location La are not limited thereto.

In some embodiments, user of mobile device 130_1 is an average consumer who generates control signal via mobile device 130_1 to notify server 120 of his/her intend to end rental and return vehicle 110, and further enable server 120 to switch vehicle 110 to locked state. In other embodiments, user of mobile device 130_1 is an operation and maintenance personnel who generates control signal via mobile device 130_1 to notify server 120 of his/her completion of on-site maintenance for vehicle 110.

At step S206, server 120 may determine a first drifting range Ra according to reference location La. In some embodiments, first drifting range Ra is centered at reference location La and is used for observing location relationship between reference location La and positioning locations of vehicle 110 after receipt of control signal.

In some embodiments, first drifting range Ra is circular, where a diameter of first drifting range Ra is approximately 50 meters. However, this disclosure is not limited thereto. For example, under consideration for operational requirement or operating precision, the diameter of first drifting range Ra may be larger than or smaller than 50 meters (e.g., 20 or 30 meters), and first drifting range Ra may be of a different shape, such as rectangle.

At step S208, server 120 determines a latest positioning location uploaded by vehicle 110 (e.g., positioning circuit 118 is configured to generate positioning location of vehicle 110 following upload period of a minute) after receipt of control signal as a current location Lb of vehicle 110. A person of ordinary skill in the art can understand that, in contrast to positioning during a moving state, positioning location of vehicle 110 at a static state is prone to drifting effect comparing to its actual position. Therefore, reference location La and current location Lb of vehicle 110 might be different from each other after end of rental (assuming it has yet been rented by other users). In addition, reference location La, under the drifting effect, might as well not be actual location of vehicle 110 during ending of rental. Considering the above, the present disclosure takes first drifting range Ra defined by reference location La to observe location relationship between reference location La and current location Lb and act as a reasonable drifting range for using current location Lb as a reference toward actual location of vehicle 110. If current location Lb is outside of first drifting range Ra, it indicates that possible error of using current location Lb as a reference toward the actual location of vehicle 110 is too significant and its reference value is therefore lost. In other additional embodiments, other drifting ranges different from first drifting range Ra may be implemented and applied for different reference uses, which will be described in detail later.

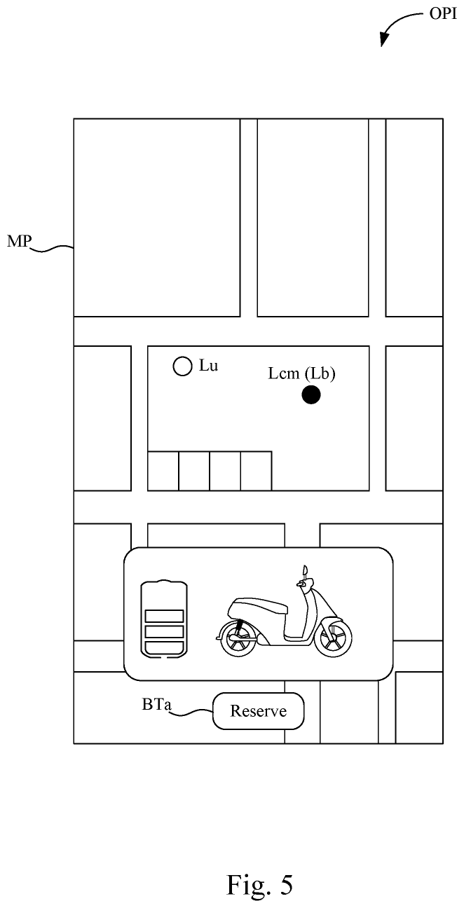

Reference is made to FIG. 3 and FIG. 5, where FIG. 5 is a schematic diagram of a screenshot of the mobile device for illustrating method 200. In some embodiments, FIG. 5 illustrates an operational interface OPI for application software installed in mobile devices 130_1-130_n. Operational interface OPI includes a map MP and a reservation button BTa. Operational interface OPI is also configured to display a user location Lu (i.e., positioning location of a corresponding one of mobile devices 130_1-130_n) and a real-time recommendation location Lcm of vehicle 110. In other words, operational interface OPI is configured to display user location Lu and real-time recommendation location Lcm of vehicle 110 on map MP. At step S210, server 120 determines whether current location Lb of vehicle 110 is within first drifting range Ra and selects means to generate real-time recommendation location Lcm of vehicle 110 on operational interface OPI according to the determination result, from which real-time recommendation location Lcm is configured to be displayed on map MP of operational interface OPI to provide reference for user to locate vehicle 110 on-site.

If determination result of step S210 is “YES” (e.g., the latest positioning location uploaded by vehicle 110 is current location Lb within first drifting range Ra of FIG. 4), server 120 conducts step S212 to determine current location Lb of vehicle 110 (i.e., latest positioning location uploaded by vehicle 110) as real-time recommendation location Lcm. Then, server 120 conducts step S216 to transmit real-time recommendation location Lom to mobile devices 130_1-130_n and allow mobile devices 130_1-130_n to display vehicle 110 as being at real-time recommendation location Lom on map MP of operational interface OPI, as shown in FIG. 5.

If determination result of step S210 is “NO” (e.g., the latest positioning location uploaded by vehicle 110 is a current location Lb′ outside of first drifting range Ra of FIG. 4), server 120 determines current positioning location of vehicle 110 lacks reference value and conducts step S214. At step S214, server 120 looks up each historical positioning location recorded after end of rental for vehicle 110, and determine a historical positioning location within first drifting range Ra generated at a closest time point right before positioning location of vehicle 110 drifts outside first drifting range Ra, thereby using such historical positioning location as real-time recommendation location Lcm. In other words, server 120 determines, among at least one historical positioning location, a latest recorded one of the one or more of historical positioning locations within first drifting range Ra as real-time recommendation location Lcm. Then, server 120 conducts step S216.

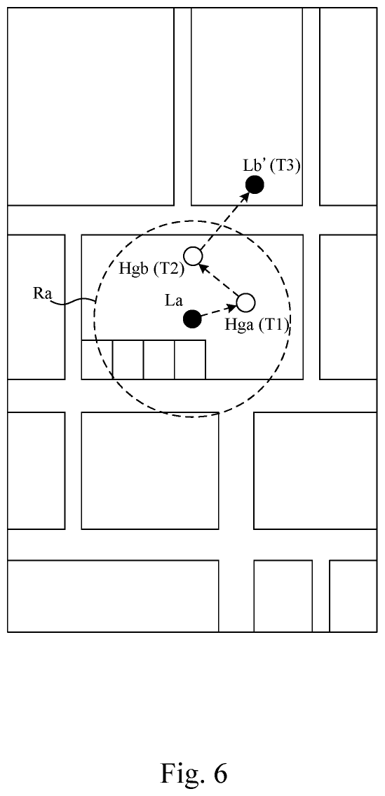

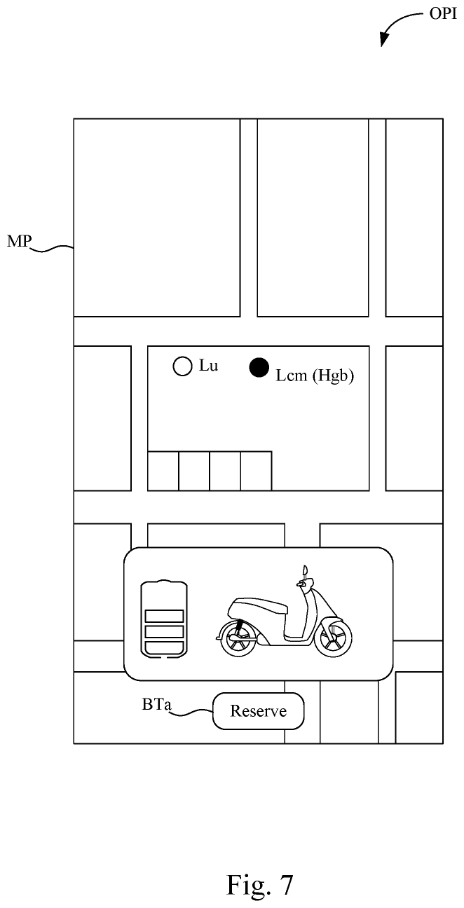

Reference is made to FIG. 3, FIG. 6 and FIG. 7, where FIG. 6 is a schematic diagram for illustrating the aforementioned step S214, and FIG. 7 is a schematic diagram of a screenshot of mobile device for illustrating method 200. First refer to FIG. 6, assumption is that vehicle 110 has uploaded a historical positioning location Hga, a historical positioning location Hgb and a current location Lb′ sequentially at time point T1, T2 and T3 respectively, where current location Lb′ is latest positioning location of vehicle 110. From here, at step S214, server 120 selects historical positioning location Hgb, which is the last one within first drifting range Ra, as real-time recommendation location Lcm. Then, server 120 conducts step S216 to allow mobile devices 130_1-130_n display real-time recommendation location Lcm, as shown in FIG. 7.

In additional embodiments, step S214 may display real-time recommendation location Lom in other manners, and is not limited to description of FIG. 7. As an example, an additional drifting range centered at reference location La which is larger than and encompasses first drifting range Ra may be implemented. This additional drifting range is configured to indicate a situation where positioning location uploaded by vehicle 110 is extremely unsatisfactory (e.g., scenarios where positioning location(s) drifting too far outside first drifting range Ra, positioning locations uploaded by vehicle 110 are all outside of first drifting range Ra, etc.). When positioning location(s) of vehicle 110 being detected as outside this additional drifting range, real-time recommendation location Lom is instead displayed at reference location La.

The following steps S218-S220 are related to guiding users to search and rent vehicle 110. For convenience of understanding, the following description is made under assumption that user of mobile device 130_2 executes application software to search and rent vehicle 110 after user of mobile device 130_1 returned vehicle 110. Steps S218-S220 will take mobile device 130_2 as an example for illustration (notably, other mobile devices, including mobile device 130_1, can conduct the same steps).

Reference is made to FIG. 3 and FIG. 5 (or FIG. 7), in various of the aforementioned scenarios, user of mobile device 130_2 can tap on real-time recommendation location Lcm to select vehicle 110 intended for rent, and then tap on reservation button BTa to make a rental reservation for vehicle 110. In this scenario, mobile device 130_2 transmits a reservation signal corresponding to vehicle 110 to server 120. As a response, server 120 may conduct step S218 and control vehicle 110 and/or operational interface OPI of mobile device 130_2 to generate notification(s), so as to guide user in finding vehicle 110.

In some embodiments, step S218 may be conducted simultaneously with steps S208-S216.

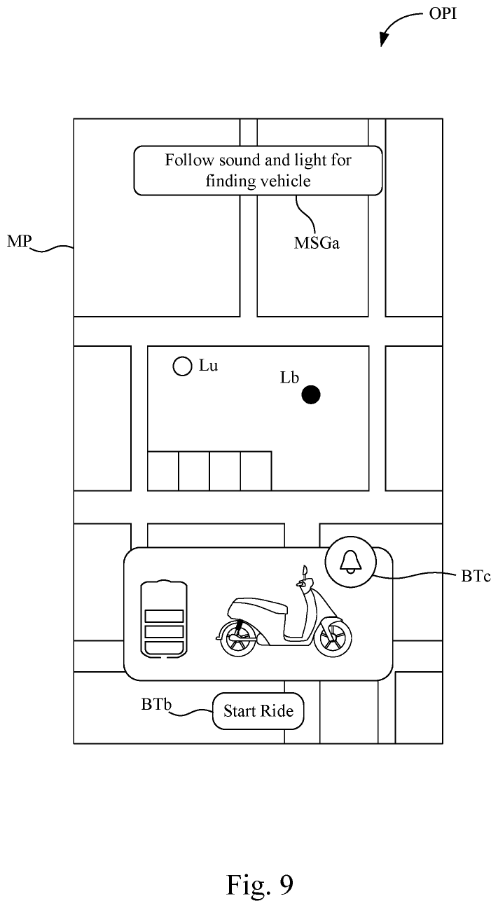

When user taps on reservation button BTa, the application software provides a rent button BTb and a search button BTc on operational interface OPI (depicted in FIGS. 9-11). In accordance to scenarios where user taps on rent button BTb or it is determined that user has declined to rent (e.g., user has canceled the reservation or failed to rent after reservation time period has exceeded), mobile device 130_2 transmits a start-to-rent signal or a canceling-of-reservation signal to server 120 accordingly. Responsively, server 120 may conduct step S220 to: switch vehicle 110 from locked state to unlocked state based on the start-to-rent signal and allow rental for user of mobile device 130_2; or cancel the reservation for user of mobile device 130_2 based on the canceling-of-reservation signal.

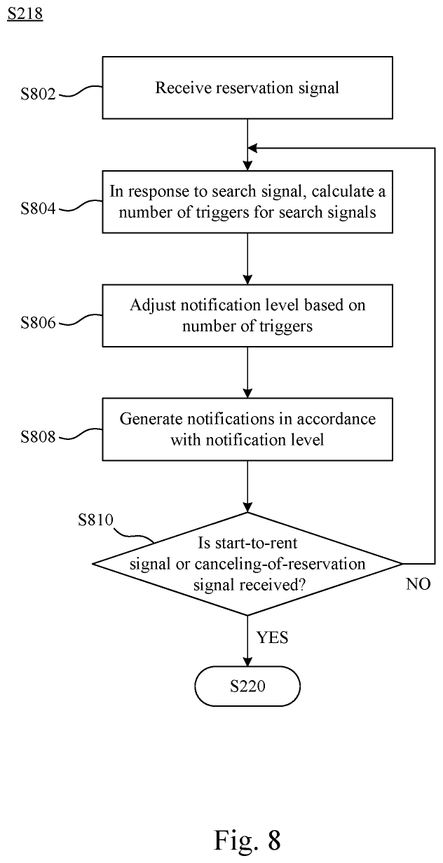

Step S218 will be discussed in greater detail with reference to FIGS. 8-11, where FIG. 8 is a detailed flowchart of step S218 according to one embodiment of the present disclosure, and FIGS. 9-11 are schematic diagrams of screenshots of mobile device for illustrating step S218. Step S218 comprises steps S802-S810.

At step S802, server 120 first confirms a reservation signal received from mobile device 130_2 regarding an intention to rent vehicle 110. From here application software will provide a rent button BTb and search button BTc on operational interface OPI (as depicted in FIGS. 9-11) during reserved status of vehicle 110 for user to confirm proceed with rental of vehicle 110.

At step S804, in response to reservation signal, server 120 is configured to receive search signal corresponding to vehicle 110 triggered during a reserved status of vehicle 110, and to calculate a number of triggers for search signals regarding vehicle 110. Specifically, in scenarios where user makes reservation for vehicle 110 but cannot find vehicle 110 on-site, user may tap on search button BTc on operational interface OPI to trigger a search signal in request of server 120 to guide user finding vehicle 110. In other scenarios, server 120 may also voluntarily trigger search signal when it proactively determines user has yet to find vehicle 110 even if search button BTc is not being tapped. Such scenario may correspond to a detection that vehicle 110 is yet being rented after a period (e.g., thirty seconds) has elapsed under reserved status and a determination that user has yet to operate the operational interface OPI (search button BTc). Step S804 is configured for determining adjustment to a notification level based on number of triggers of these accumulated search signals thereafter.

At step S806, server 120 adjusts a notification level for guiding user finding vehicle 110 based on number of triggers for search signals. Specifically, server 120 may configure notification level to adjust in accordance with accumulation of number of triggers for search signals. Preferably, notification level is adjusted based on an accumulate threshold for number of triggers (e.g., notification level is raised by one level with every accumulated three triggers of search signals). In this disclosure, the greater number of adjustments to notification level (e.g., the higher the notification level) indicates a stronger guidance to be provided to user for finding vehicle 110.

At step S808, server 120 controls vehicle 110 and/or operational interface OPI to generate notifications or guidance at a corresponding degree to a current notification level. In some embodiments, notifications generated in accordance with notification level and its possible variations should be fully understood from FIGS. 9-11 and the following descriptions.

First refer to FIG. 9, notification performed in accordance with notification level may include: let server 120 control operational interface OPI to generate notification message MSGa, of which notification message MSGa is configured to remind user be wary of light or sound notification (e.g., notification in forms of light-flashing or honking) generated by vehicle 110 under control of server 120. In partial alternative embodiments, intensity or frequency of notification generated by vehicle 110 under control of server 120 is positively correlated with number of adjustments to notification level and said intensity or frequency should be adjusted in accordance with notification level following trigger of search signal.

In other embodiments, since storage circuit 126 of FIG. 1 stores land-use zoning data from governmental open data portal, which comprises locations and areas of different partitions of residence district, commercial district, agricultural district, etc., server 120 may further determine, at step S808, a district and a time of a corresponding time zone where current location Lb uploaded by vehicle 110 is located. When server 120 determines current location Lb is at a residence district and/or its corresponding time zone is at noise control hours (e.g., a period between 21 post meridiem to 4 ante meridiem), server 120 may control vehicle 110 to generate only light notification without sound notification, so as to preserve living quality for residents at surrounding area of vehicle 110. When server 120 determines that current location Lb is at a commercial district or an industrial district, server 120 may increase intensity of sound notification at each notification level, thus effectively notify user by overcoming environment noise.

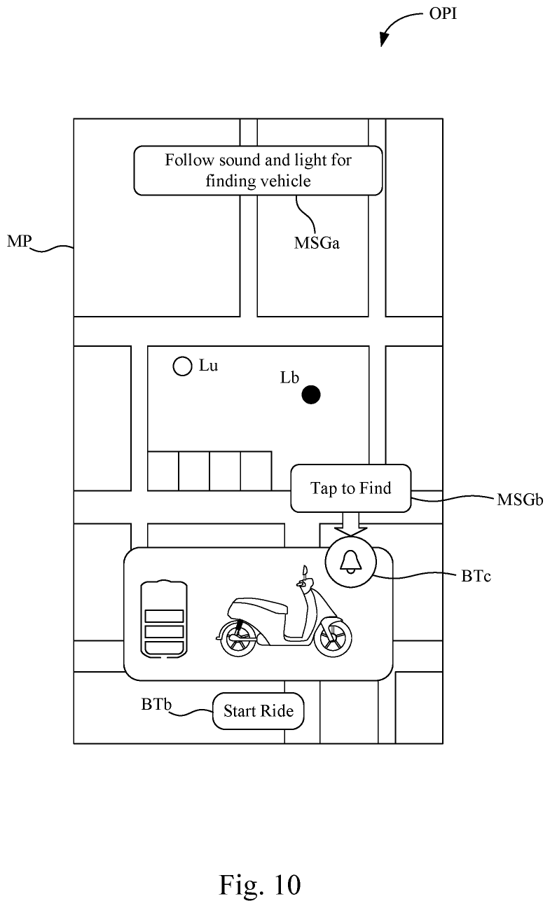

Please refer to FIG. 10, for scenarios where search signal is voluntarily triggered by server 120 (i.e., user does not tap on search button BTc nor start rental of vehicle 110), notification performed in accordance with notification level may further include: let server 120 control operational interface OPI to generate notification message MSGb, of which notification message MSGb is configured to remind user to tap on search button BTc and prompt trigger of search signal to enable server 120 guide user find vehicle 110 in a stronger manner.

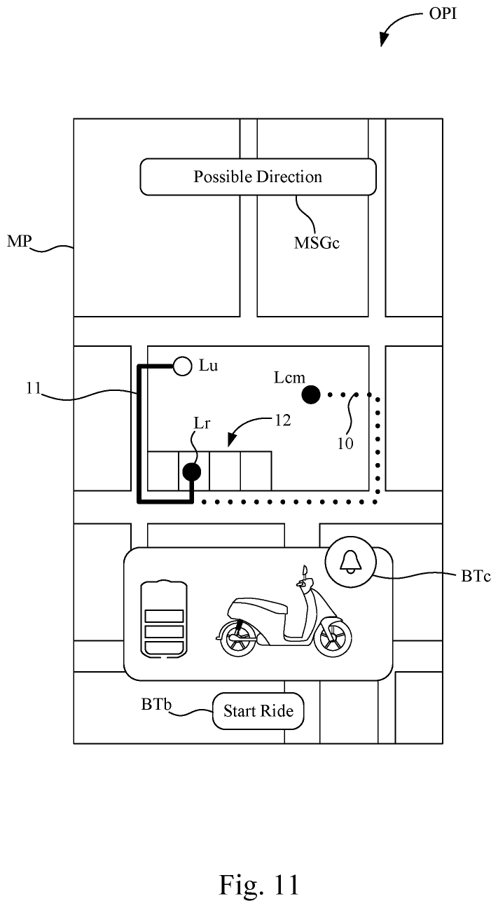

Please refer to FIG. 11, for scenarios where notification level has reached a predefined threshold (e.g., predefined threshold is a level X indicated by a suitable positive integer X, where notification level reaching level X denoted a situation that user failed to find vehicle 110 after multiple taps on search button BTc and/or a considerable long time period has elapsed), notification performed in accordance with notification level may further include: let server 120 estimate, according to auxiliary geographic data corresponding to first drifting range Ra, a real-time candidate location Lr where vehicle 110 is most likely located and control mobile device 130_2 to display a real-time candidate location Lr on operational interface OPI to recommend guidance for finding vehicle 110. In some embodiments, server 120 further controls mobile device 130_2 to display, on operational interface OPI, at least one of: (1) an icon 10 directing from real-time recommendation location Lom to real-time candidate location Lr, and (2) an icon 11 directing from user location Lu to real-time candidate location Lr. However, appearances of icon 10 and icon 11 are not limited to those depicted in FIG. 11. In some embodiments, server 120 further controls mobile device 130_2 to generate a notification message MSGc, where notification message MSGc is configured to remind user to follow guidance recommended by icon 10 or icon 11 for finding vehicle 110.

The following describes how real-time candidate location Lr is determined. If storage circuit 126 of FIG. 1 has parking space data corresponding to first drifting range Ra stored, server 120 may configure real-time candidate location Lr at parking space location recorded in parking space data (e.g., parking space location 12 within first drifting range Ra, as shown in FIG. 11). If storage circuit 126 of FIG. 1 has drifting data corresponding to first drifting range Ra (e.g., drift offset and drift direction of past positioning location generated by vehicle 110 when parked at location within first drifting range Ra) stored, server 120 may provide real-time recommendation location Lcm and drifting data as input to a machine learning module, utilize the machine learning module to generate real-time candidate location Lr via deducing real-time recommendation location Lcm to a most possible corresponding location before positioning is affected by drifting effect according to drifting offset and drifting direction of the drifting data. The machine learning module may be configured in storage circuit 126 of FIG. 1.

In some embodiments, if storage circuit 126 has both parking space data and drifting data stored, server 120 may select a preferred one from two types of real-time candidate locations Lr respectively generated from parking space data and drifting data that is linearity closest to reference location La and control mobile device 130_2 to display the selected real-time candidate location Lr. In other embodiments, server 120 may select a preferred one from two types of real-time candidate locations Lr respectively generated from parking space data and drifting data that is closest to user location Lu (e.g., the one that forms shortest path length for icon 11) and control mobile device 130_2 to display the selected real-time candidate location Lr. In other embodiments, server 120 may control mobile device 130_2 to concurrently display two types of real-time candidate locations Lr respectively generated from parking space data and drifting data.

The above scenario where storage circuit 126 of FIG. 1 has parking space data or drifting data corresponding to first drifting range Ra stored can be understood as auxiliary geographic data corresponding to first drifting range Ra being accessible. When auxiliary geographic data corresponding to first drifting range Ra is accessible, server 120 generates real-time candidate locations Lr according to at least one of parking space data and drifting data. On the other hand, if storage circuit 126 does not have parking space data and drifting data corresponding to first drifting range Ra stored (i.e., auxiliary geographic data corresponding to first drifting range Ra is inaccessible), server 120 may instead configure real-time candidate location Lr at reference location La.

In additional embodiments, determination of real-time candidate location Lr may be accomplished by other suitable manners and this disclosure is not limited to those discussed above. For example, a further drifting range centered at reference location La may be additionally configured, and server 120 may average historical positioning locations and reference location La of vehicle 110 within this further drifting range to obtain a new central position, where the new central position is displayed on mobile device 130_2 as real-time candidate location Lr.

At step S810, server 120 determines whether start-to-rent signal or canceling-of-reservation signal is received. If yes, server 120 conducts step S220. If not, server 120 repeats step S804.

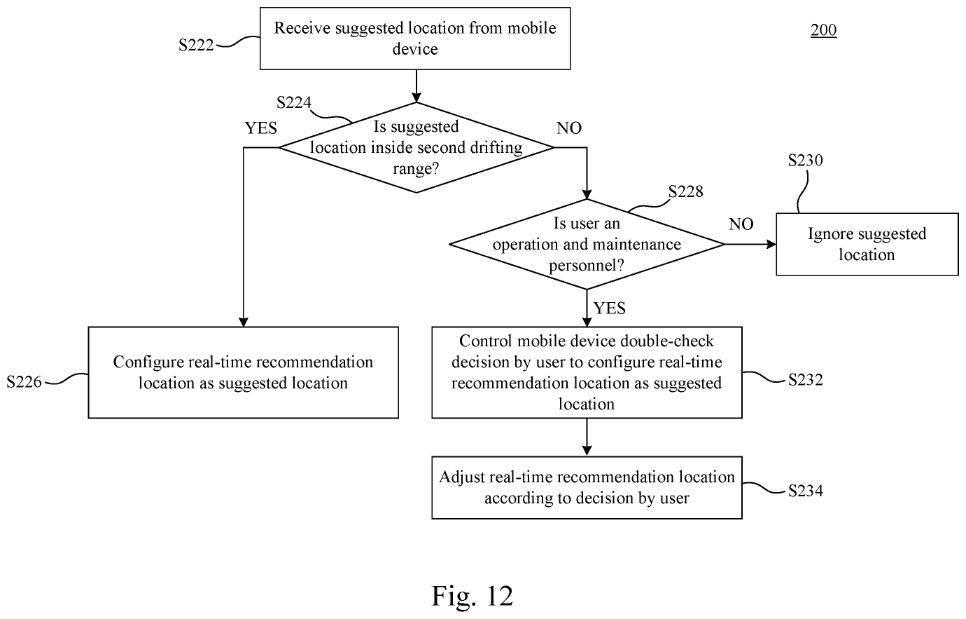

FIG. 12 is a partial flowchart of method 200 according to one embodiment of the present disclosure. In some embodiments, method 200 further comprises steps S222-S234, which may be performed in parallel with steps S208-S216 to realize allowance for manual recommendation of real-time recommendation location Lom of vehicle 110 by user through mobile devices 130_1-130_n upon actual location of vehicle 110 is confirmed by user on-site. For convenience of description, the following description is made under assumption where manual recommendation is conducted by user of mobile device 130_3. However, this disclosure is not limited thereto, and each of mobile devices 130_1-130_n is enabled to perform said manual recommendation.

At step S222, server 120 receives a suggested location input by user from mobile device 130_3. In some embodiments, user of mobile device 130_3 may drag a real-time recommendation location Lcm displayed by mobile device 130_3 to any location on map MP, and mobile device 130_3 may transmit such location to server 120 as a suggested location. However, receival of suggested location from user is not limited to dragging and can be realized by other suitable manners (e.g., via manual input) depending on operational requirements, and thus the present disclosure is not limited thereto.

At step S224, server 120 determines whether suggested location is within a second drifting range (not shown). If yes, server 120 conducts step S226 and configures real-time recommendation location Lcm at the suggested location. If not, server 120 then conducts step S228 to determine whether uploader of the suggested location (i.e., user of mobile device 130_3) has authority of operation and maintenance personnel. The second drifting range is a range also centered at reference location La. It can be of a same range as first drifting range Ra, or alternatively, can be configured with range different from first drifting range Ra (e.g., larger than first drifting range Ra) in consider of operation convenience for manual recommendation, of which this disclosure is not limited thereto.

If determination of step S228 is “NO” (e.g., uploader of suggested location only has authority of average user), server 120 conducts step S230 and ignores the suggested location for manual recommendation. On the other hand, if determination of S228 is “YES,” server 120 conducts step S232 and controls mobile device 130_3 to double-check with user regarding decision to configure real-time recommendation location Lcm at the suggested location. For example, mobile device 130_3 may display buttons representing “YES” and “NO” on operational interface OPI respectively to confirm said decision. Then, server 120 conducts step S234 and adjusts real-time recommendation location Lcm according to selection by user. For example, if user selects “YES,” server 120 configures real-time recommendation location Lcm at suggested location; whereas if user selects “NO,” server 120 ignores the suggested location for manual recommendation.

In some embodiments, as server 120 configures real-time recommendation location Lom at the suggested location, server 120 not only enable each of mobile devices 130_1-130_n to display newly configured real-time recommendation location Lcm on the operational interface OPI, but also reconfigures first drifting range Ra according to the suggested location. In other words, server 120 centers first drifting range Ra at the suggested location after acceptance of manual recommendation.

Accordingly, with analysis on various geographic data and historical positioning locations of vehicle 110, system 100 and method 200 of the present disclosure can effectively recommend guidance to user for finding vehicle 110 despite existence of drifting effect. Therefore, customer service costs and operation costs are reduced, and user experience is improved.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

Certain terms are used in specification and claims to refer to specific components. However, those of ordinary skill in the art would understand that the same components may be referred to by different terms. The specification and claims do not use the differences in terms as a way to distinguish components, but the differences in functions of the components are used as a basis for distinguishing. Furthermore, it should be understood that the term “comprising” used in the specification and claims is open-ended, that is, including but not limited to. In addition, “coupling” herein includes any direct and indirect connection means. Therefore, if it is described that the first component is coupled to the second component, it means that the first component can be directly connected to the second component through electrical connection or signal connections including wireless transmission, optical transmission, and the like, or the first component is indirectly electrically or signally connected to the second component through other component(s) or connection means.

It will be understood that, in the description herein and throughout the claims that follow, the phrase “and/or” includes any and all combinations of one or more of the associated listed items. Unless the context clearly dictates otherwise, the singular terms used herein include plural referents.

The foregoing merely described preferred embodiments of the present disclosure, meaning various modifications and equivalent variations can be made to the present disclosure without departing from the scope or spirit of the present disclosure. In view of the foregoing, it is intended that the present disclosure covers modifications and equivalent variations made to this disclosure provided under scope of the following claims.

What is claimed is:

1. A computer-implemented method for recommending vehicle location, comprising:
recording at least one positioning location of a vehicle at real-time as at least one historical positioning location of the vehicle;
in response to receiving a control signal corresponding to the vehicle from a first mobile device of at least one mobile device, determining a reference location of the vehicle according to the at least one historical positioning location;
according to a location relationship between the reference location and a current location of the at least one positioning location, generating a real-time recommendation location of the vehicle; and
transmitting the real-time recommendation location to the at least one mobile device, and allowing each of the at least one mobile device to display the real-time recommendation location on an operational interface.

2. The method for recommending vehicle location of claim 1, wherein determining the reference location of the vehicle according to the at least one historical positioning location comprises:
obtaining a central position of one or more of the at least one historical positioning location recorded during a period where the vehicle entering a static state to receiving the control signal; and
using the central position as the reference location.

3. The method for recommending vehicle location of claim 1, wherein the control signal indicates a user has ended rental and returned the vehicle, or an operation and maintenance personnel has completed on-site maintenance for the vehicle.

4. The method for recommending vehicle location of claim 1, wherein generating the real-time recommendation location of the vehicle comprises:
if the location relationship indicates the current location being within a first drifting range centered at the reference location, using the current location as the real-time recommendation location; or
if the location relationship indicates the current location being outside the first drifting range, using a latest recorded one of one or more of the at least one historical positioning location within the first drifting range as the real-time recommendation location.

5. The method for recommending vehicle location of claim 1, further comprising:
receiving, from a second mobile device of the at least one mobile device, a reservation signal corresponding to the vehicle;
in response to the reservation signal, receiving a search signal corresponding to the vehicle triggered during a reserved status of the vehicle;
adjusting, according to a number of triggers of the search signal, a notification level; and
controlling, according to the notification level: (1) a frequency and/or an intensity of a notification generated by the vehicle, and/or (2) the operational interface displayed by the second mobile device.

6. The method for recommending vehicle location of claim 5, wherein
the notification level is adjusted based on an accumulate threshold for the number of triggers; and wherein
the frequency and/or the intensity is positively correlated with a number of adjustments to the notification level under adjustment.

7. The method for recommending vehicle location of claim 5, wherein controlling the operational interface displayed by the second mobile device comprises:
controlling the second mobile device to display a notification message, wherein the notification message is configured to remind a user to control the operational interface displayed by the second mobile device and trigger the search signal.

8. The method for recommending vehicle location of claim 5, wherein controlling the operational interface displayed by the second mobile device comprises:
generating a real-time candidate location of the vehicle according to an auxiliary geographic data corresponding to a first drifting range centered at the reference location; and
displaying the real-time candidate location in a map of the operational interface displayed by the second mobile device.

9. The method for recommending vehicle location of claim 8, wherein
the auxiliary geographic data comprises a parking space data and a drifting data corresponding to the first drifting range; and wherein
the drifting data comprises a drifting offset and a drifting direction regarding positioning error corresponding to actual location of the vehicle.

10. The method for recommending vehicle location of claim 9, wherein
if the auxiliary geographic data corresponding to the first drifting range is accessible, the real-time candidate location is generated according to at least one of the parking space data and the drifting data; or
if the auxiliary geographic data corresponding to the first drifting range is inaccessible, the real-time candidate location is configured as the reference location.

11. A system for recommending vehicle location, comprising:
a vehicle;
at least one mobile device comprising a first mobile device; and
a server communicatively coupled with the vehicle and the at least one mobile device, and configured to:
record at least one positioning location of the vehicle at real-time as at least one historical positioning location of the vehicle;
in response to receiving a control signal corresponding to the vehicle from the first mobile device, determine a reference location of the vehicle according to the at least one historical positioning location;
according to a location relationship between the reference location and a current location of the at least one positioning location, generate a real-time recommendation location of the vehicle; and
transmit the real-time recommendation location to the at least one mobile device, and allow each of the at least one mobile device to display the real-time recommendation location on an operational interface.

12. The system for recommending vehicle location of claim 11, wherein when the server is configured to determine the reference location of the vehicle according to the at least one historical positioning location, the server is further configured to:
obtain a central position of one or more of the at least one historical positioning location recorded during a period where the vehicle entering a static state to receiving the control signal; and
use the central position as the reference location.

13. The system for recommending vehicle location of claim 11, wherein the control signal is configured to notify the server a user has ended rental and returned the vehicle, or is configured to notify the server an operation and maintenance personnel has completed an on-site maintenance for the vehicle.

14. The system for recommending vehicle location of claim 11, wherein when the server generates the real-time recommendation location of the vehicle according to the location relationship between the reference location and the current location of the at least one positioning location, the server is further configured to:
if the current location is within a first drifting range centered at the reference location, use the current location as the real-time recommendation location; or
if the current location is outside the first drifting range, use a latest recorded one of one or more of the at least one historical positioning location within the first drifting range as the real-time recommendation location.

15. The system for recommending vehicle location of claim 11, wherein the server is further configured to:
receive a reservation signal corresponding to the vehicle from a second mobile device of the at least one mobile device;
in response to the reservation signal, receive a search signal corresponding to the vehicle triggered during a reserved status of the vehicle;
adjust a notification level according to a number of triggers of the search signal; and
control, according to the notification level: (1) a frequency and/or an intensity of a notification generated by the vehicle, and/or (2) the operational interface displayed by the second mobile device.

16. The system for recommending vehicle location of claim 15, wherein
the notification level is adjusted based on an accumulate threshold of the number of triggers; and wherein
the frequency and/or the intensity if positively correlated with a number of adjustments of the notification level.

17. The system for recommending vehicle location of claim 15, wherein
the operational interface displayed by the second mobile device comprises a notification message, and wherein
the notification message is configured to remind a user to control the operational interface displayed by the second mobile device and trigger the search signal.

18. The system for recommending vehicle location of claim 15, wherein when the server controls, according to the notification level, the operational interface displayed by the second mobile device, the server is further configured to:
generate a real-time candidate location of the vehicle according to an auxiliary geographic data corresponding to a first drifting range centered at the reference location; and
display the real-time candidate location in a map of the operational interface displayed by the second mobile device.

19. The system for recommending vehicle location of claim 18, wherein
the auxiliary geographic data comprises a parking space data and a drifting data correspond to the first drifting range, and wherein
the drifting data comprises a drifting offset and a drifting direction regarding positioning error corresponding to actual location of the vehicle.

20. The system for recommending vehicle location of claim 19, wherein
if the auxiliary geographic data corresponding to the first drifting range is accessible, the real-time candidate location is generated according to at least one of the parking space data and the drifting data; or
if the auxiliary geographic data corresponding to the first drifting range is inaccessible, the real-time candidate location is configured as the reference location.
